(19) United States
(12) Patent Application Publication
(10) Pub. No.: US 2013/0259312 A1
(43) Pub. Date: Oct. 3, 2013

(54) Eye Gaze Based Location Selection for Audio Visual Playback

(71) Applicants: Kenton M. Lyons, Santa Clara, CA (US); Joshua J. Ratcliff, San Jose, CA (US); Trevor Pering, San Francisco, CA (US)

(72) Inventors: Kenton M. Lyons, Santa Clara, CA (US); Joshua J. Ratcliff, San Jose, CA (US); Trevor Pering, San Francisco, CA (US)

(21) Appl. No.: 13/993,245

(22) PCT Filed: Sep. 8, 2011
(86) PCT No.: PCT/US2011/050895

§ 371 Date: Jun. 11, 2013

(51) Int. Cl. G06K 9/00; H04N 9/87

(52) U.S. Cl. CPC G06K 9/00711; H04N 9/87
USPC 382/103; 386/230

(57) ABSTRACT

In response to the detection of what the user is looking at on a display screen, the playback of audio or visual media associated with that region may be modified. For example, video in the region the user is looking at may be sped up or slowed down. A still image in the region of interest may be transformed into a moving picture. Audio associated with an object depicted in the region of interest on the display screen may be activated in response to user gaze detection.

### BACKGROUND

This relates generally to computers and, particularly, to displaying images and playing back audio visual information on computers.

Typically, computers include a number of controls for audio/video playback. Input/output devices for this purpose include keyboards, mice, and touch screens. In addition, graphical user interfaces can be displayed to enable user control of the start and stop of video or audio playback, pausing video or audio playback, fast forward of video or audio playback, and rewinding of audio/video playback.

### BRIEF DESCRIPTION OF THE DRAWINGS

FIG. 1 is a schematic depiction of one embodiment of the present invention; and

FIG. 2 is a flow chart for one embodiment of the present invention.

### DETAILED DESCRIPTION

In accordance with some embodiments, a user's eye gaze can be analyzed to determine exactly what the user is looking at on a computer display screen. Based on the eye gaze detected region of user interest, audio or video playback may be controlled. For example, when the user looks at a particular region on the display screen, a selected audio file or a selected video file may begin playback in that area.

Similarly, based on where the user is looking, the rate of motion of video may be changed in that area. As another example, motion may be turned on in a region that was still before the user looked at the region. As additional examples, the size of an eye gaze selected region may be increased or decreased in response to the detection of the user looking at the region. Fast forward, forward, or rewind controls may also be instituted in a display region simply based on the fact that the user looks at a particular region. Other controls that may be implemented merely by detecting eye gaze includes pause and playback start up.

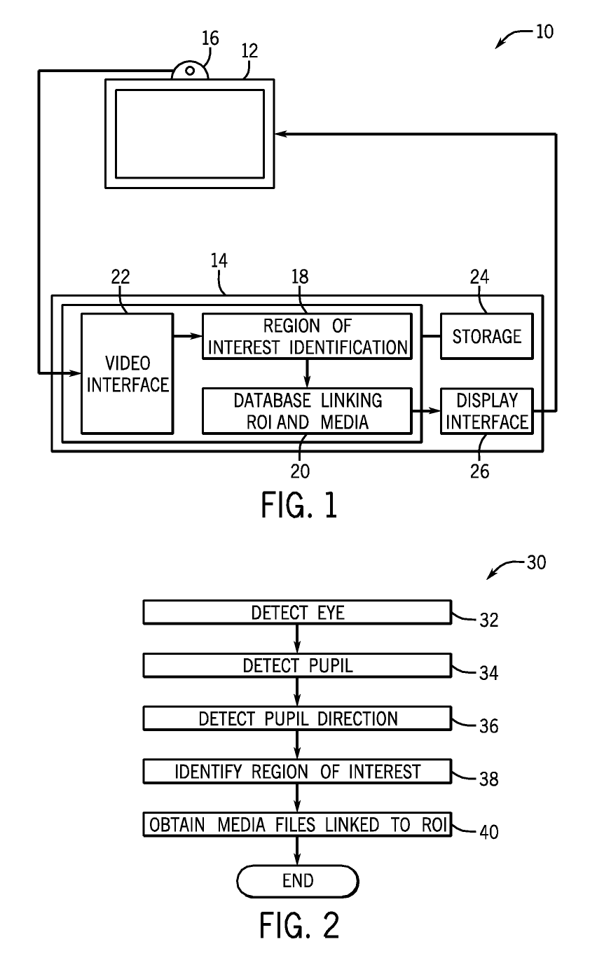

Referring to FIG. 1, a computer system 10 may be any kind of processor-based system, including a desktop computer or an entertainment system, such as a television or media player. It may also be a mobile system, such as a laptop computer, a tablet, a cellular telephone, or a mobile Internet device, to mention some examples.

The system 10 may include a display screen 12, coupled to a computer based device 14. The computer based device may include a video interface 22, coupled to a video camera 16, which, in some embodiments, may be associated with the display 12. For example, the camera 16 may be integrated with or mounted with the display 12, in some embodiments. In some embodiments, infrared transmitters may also be provided to enable the camera to detect infrared reflections from the user's eyes for tracking eye movement. As used herein, “eye gaze detection” includes any technique for determining what the user is looking at, including eye, head, and face tracking.

A processor 28 may be coupled to a storage 24 and display interface 26 that drives the display 12. The processor 28 may be any controller, including a central processing unit or a graphics processing unit. The processor 28 may have a module 18 that identifies regions of interest within the image displayed on the display screen 12 using eye gaze detection.

In some embodiments, the determination of an eye gaze location on the display screen may be supplemented by image analysis. Specifically, the content of the image may be analyzed using video image analysis to recognize objects within the depiction and to assess whether the location suggested by eye gaze detection is rigorously correct. As an example, the user may be looking at an imaged person's head, but the eye gaze detection technology may be slightly wrong, suggesting, instead, that the area of focus is close to the head, but in a blank area. Video analytics may be used to detect that the only object in proximity to the detected eye gaze location is the imaged person's head. Therefore, the system may deduce that the true focus is the imaged person's head. Thus, video image analysis may be used in conjunction with eye gaze detection to improve the accuracy of eye gaze detection in some embodiments.

The region of interest identification module 18 is coupled to a region of interest and media linking module 20. The linking module 20 may be responsible for linking what the user is looking at to a particular audio visual file being played on the screen. Thus, each region within the display screen, in one embodiment, is linked to particular files at particular instances of time or at particular places in the ongoing display of audio visual information.

For example, time codes in a movie may be linked to particular regions and metadata associated with digital streaming media may identify frames and quadrants or regions within frames. For example, each frame may be divided into quadrants which are identified in metadata in a digital content stream.

As another example, each image portion or distinct image, such as a particular object or a particular region, may be a separately manipulateable file or digital electronic stream. Each of these distinct files or streams may be linked to other files or streams that can be activated under particular circumstances. Moreover, each discrete file or stream may be deactivated or controlled, as described hereinafter.

In some embodiments, a series of different versions of a displayed electronic media file may be stored. For example, a first version may have video in a first region, a second version may have video in a second region, and a third version may have no video. When the user looks at the first region, the playback of the third version is replaced by playback of the first version. Then, if the user looks at the second region, playback of the first version is replaced by playback of the second version.

Similarly, audio can be handled in the same way. In addition, beam forming techniques may be used to record the audio of the scene so that the audio associated with different microphones in a microphone array may be keyed to different areas of the imaged scene. Thus, when the user is looking at one area of a scene, audio from the most proximate microphone may be played in one embodiment. In this way, the audio playback correlates to the area within the imaged scene that the user is actually gazing upon.

In some embodiments, a plurality of videos may be taken of different objects within the scene. Green screen techniques may be used to record these objects so that they can be stitched into an overall composite. Thus, to give an example, a video of a fountain in a park spraying water may be recorded using green screen techniques. Then the video that is playing may show the fountain without the water spraying. However, the depiction of the fountain object may be removed from the scene when the user looks at it and may be replaced by a stitched in segmented display of the fountain actually spraying water. Thus, the overall scene may be made up of a composite of segmented videos which may be stitched into the composite when the user is looking at the location of the object.

In some cases, the display may be segmented into a variety of videos representing a number of objects within the scene. Whenever the user looks at one of these objects, video of the object may be stitched into the overall composite to change the appearance of the object.

The linking module 26 may be coupled to a display driver 26 for driving the display. The module 26 may also have available storage 24 for storing files that may be activated and played in association with the selection of particular regions of the screen.

Thus, referring to FIG. 2, a sequence 30 may be implemented by software, firmware, and/or hardware. In software or firmware embodiments, the sequence may be implemented by computer readable instructions stored on a non-transitory computer readable medium, such as an optical, magnetic, or semiconductor storage. For example, such a sequence embodied in computer readable instructions could be stored in the storage 24.

In one embodiment, the sequence 30 begins by detecting the user's eye locations (block 32) within the video feed from the video camera 16. Well known techniques may be used to identify image portions that correspond to the well known physical characteristics associated with the human eye.

Next, at block 34, the region identified as the eye is searched for the human pupil, again, using its well known, geometrical shape for identification purposes in one embodiment.

Once the pupils have been located, pupil movement may be tracked (block 36) using conventional eye detection and tracking technology.

The direction of movement of the pupil (block 36) may be used to identify regions of interest within the ongoing display (block 38). For example, the location of the pupil may correspond to a line of sight angle to the display screen, which may be correlated using geometry to particular pixel locations. Once those pixel locations are identified, a database or table may link particular pixel locations to particular depictions on the screen, including image objects or discrete segments or regions of the screen.

Finally, in block 40, media files may be linked to the region of interest. Again, various changes in depicted regions or objects may be automatically implemented in response to detection that the user is actually looking at the region.

For example, a selected audio may be played when the user is looking at one area of the screen. Another audio file may be automatically played when the user is looking at another region of the screen.

Similarly, video may be started within one particular area of the screen when the user looks at that area. A different video may be started when the user looks at a different area of the screen.

Likewise, if motion is already active in a region of the screen, when the user looks at that region, the rate of the motion may be increased. As another option, motion may be turned on in a still region when the user is looking at it or vice versa.

As additional examples, the size of the display of the region of interest may be increased or decreased in response to user gaze detection. Also, forward and rewind may be selectively implemented in response to user gaze detection. Still additional examples include pausing or starting playback within that region. Yet another possibility is to implement three dimensional (3D) effects in the region of interest or to deactivate 3D effects in the region of interest.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
identifying what a user is looking at on a display screen using eye gaze detection; and
modifying the playback of audio/visual media based on what a user is looking at on the display screen.

2. The method of claim 1 including playing video in a region of the display in response to the detection that the user is looking at that region.

3. The method of claim 1 including increasing the rate of motion of objects in a region of a display screen that a user is looking at.

4. The method of claim 1 including starting or stopping audio associated with the region on the display screen that the user is looking at.

5. The method of claim 1 including switching a region on the display screen that the user is looking at from a still image to a moving picture.

6. The method of claim 1 including using an eye tracker to determine what is being viewed on the display screen.

7. The method of claim 6 including using video image analysis to supplement the eye tracker.

8. The method of claim 7 including determining if the eye tracker indicates that the user is looking at a blank screen region and, if so, using video image analysis to identify an imaged object proximate to what the eye tracker determined that the user is looking at.

9. The method of claim 1 including providing beam formed audio linked to regions of the display screen and playing audio from a microphone linked to the region.

10. A non-transitory computer readable medium storing instructions that enable a computer to:
modify the playback of audio/visual media based on what a user is looking at on a display screen.

11. The medium of claim 10 further storing instructions to play video in a region the user is looking at in response to detection that the user is looking at that region.

12. The medium of claim 10 further storing instructions to increase the rate of motion of objects depicted in a region the user is looking at.

13. The medium of claim 10 further storing instructions to start or stop audio associated with a region of the display screen the user is looking at.

14. The medium of claim 10 further storing instructions to switch a region the user is looking at from a still image to a moving picture.

15. The medium of claim 10 further storing instructions to use gaze detection to determine what is being viewed on a display screen.

16. The medium of claim 15 further storing instructions to use video image analysis to supplement the gaze detection.

17. The medium of claim 16 further storing instructions to determine if gaze detection indicates that the user is looking at a blank screen region and, if so, use video image analysis to identify a proximate imaged object.

18. The medium of claim 10 further storing instructions to provide beam formed audio linked to regions of a display screen and to play the audio from a microphone linked to the identified region.

19. An apparatus comprising:
a processor;
a video interface to receive video of the user of a computer system; and
said processor to use said video to identify what a user is looking at on a display screen and to modify the playback of audio or visual media based on what the user is looking at.

20. The apparatus of claim 19 including a video display coupled to said processor.

21. The apparatus of claim 19 including a camera mounted on said video display and coupled to said video interface.

22. The apparatus of claim 19, said processor to play video in a region of the display in response to the detection that the user is looking at that region.

23. The apparatus of claim 19, said processor to increase the rate of motion of an object the user is looking at.

24. The apparatus of claim 19, said processor to start or stop audio associated with what the user is looking at.

25. The apparatus of claim 19, said processor to switch a region the user is looking at from a still image to a moving picture.

26. The apparatus of claim 19, said processor to use gaze detection to determine what is being viewed on a display screen.

27. The apparatus of claim 26, said processor to use video image analysis to supplement gaze detection.

28. The apparatus of claim 27, said processor to determine whether gaze detection indicates that a user is looking at a blank screen region and, if so, to use video image analysis to identify an imaged object proximate to the location identified based on gaze detection.

29. The apparatus of claim 28, said processor to correct gaze detection based on the proximate imaged object.

30. The apparatus of claim 19, said processor to provide beam formed audio linked to regions of a display screen and to play audio from a microphone linked to the identified region.
